(19) United States
(12) Patent Application Publication
(10) Pub. No.: US 2016/0039187 A1
(43) Pub. Date: Feb. 11, 2016

(54) EXTRUDED CARD ASSEMBLY AND METHOD OF MANUFACTURING THE SAME

(71) Applicant: Illinois Tool Works Inc., Glenview, IL (US)

(72) Inventors: Shannon K. Crawford-Taylor, Wisconsin Rapids, WI (US); Daniel Mark Szumski, Saint John, IN (US)

(21) Appl. No.: 14/819,618

(22) Filed: Aug. 6, 2015

Related U.S. Application Data
(60) Provisional application No. 62/034,901, filed on Aug. 8, 2014.

(51) Int. Cl. B32B 27/08; B32B 27/36; B29C 47/00; B32B 27/30

(52) U.S. Cl. CPC B32B 27/08; B32B 27/304; B32B 27/36; B32B 27/365; B29C 47/0021; B29C 47/0064; B32B 2425/00; B32B 2307/41; B32B 2307/402; B29L 2009/00

(57) ABSTRACT

A method of manufacturing a card assembly includes extruding a film of a core layer for the card assembly, co-extruding a film of a blocking layer for the card assembly, and bonding the film of the core layer and the film of the blocking layer. The card assembly can be separated from the film of the core layer and the film of the blocking layer that are bonded together. A card assembly includes a core layer having opposite first and second sides, and a blocking layer having opposite first and second surfaces. The second surface of the blocking layer can be bonded to the first side of the core layer such the first surface of the blocking layer is visible. The blocking layer can have a relatively thin thickness, such as no more than two mils (or another dimension), while preventing color of the core layer from being visible through the first surface of the blocking layer.

### CROSS-REFERENCE TO RELATED APPLICATIONS

This application claims priority to U.S. Provisional Application No. 62/034,901, filed 8 Aug. 2014, and titled “Extruded Card Assembly And Method Of Manufacturing The Same,” the entire disclosure of which is incorporated herein by reference.

### BACKGROUND

The present disclosure relates, at least in part, to multi-layer sheets and cards that are manufactured from these sheets. Laminated sheets and cards are used in a variety of applications, such as financial transaction cards (e.g., credit or debit cards, phone cards, gift cards, loyalty cards, etc.), security cards (e.g., identification cards), and the like. Some known sheets and cards may be formed from multiple layers of plastic based substrates, adhesives and coatings, among other layers. The cards also may include printing, graphics, and/or other features.

Some cards are desired to have a core layer that is a different color from films disposed on opposite, visible sides of the core layer. Different colors may be used to represent or correspond to logos, color schemes, or the like, of suppliers or purveyors of the cards. But, due to the thin dimensions of the cards, certain combinations of colors may be different. For example, cores formed from dark colors may bleed through or change the appearance of lighter colors on the surface films. As a result, the final product may not have the desired colors or appearance.

One attempted solution to preventing the color of the core from changing the color of the surface films is to print a thick layer of white pigmented coating onto the core beneath the surface films. But, adding this printed layer of pigments adds to the cost and complexity of the cards, and can weaken the coupling between the core and the surface films.

### BRIEF DESCRIPTION

In one embodiment, a method (e.g., for manufacturing an extruded card assembly) includes extruding a sheet of a core layer for a card assembly, co-extruding a sheet of a blocking layer for the card assembly, and bonding the sheet of the core layer and the sheet of the blocking layer. The card assembly can be separated (e.g., cut, punched, or the like) from the sheet of the core layer and the sheet of the blocking layer that are bonded together.

In one aspect, the sheet of the blocking layer has a thickness of no more than two mils.

In one aspect, the sheet of the blocking layer is formed from a color that prevents the sheet of the core layer from being visible through the blocking layer in the card assembly.

In one aspect, bonding the sheet of the core layer and the sheet of the blocking layer includes fusing the sheet of the blocking layer to the sheet of the core layer.

In one aspect, bonding the sheet of the core layer and the sheet of the blocking layer includes coupling the sheet of the blocking layer to the sheet of the core layer without use of an adhesive material between the sheet of the core layer and the sheet of the blocking layer.

In one aspect, the overlayer layer is a first blocking layer, and the method also can include extruding a sheet of a second blocking layer onto an opposite side of the core layer than the first blocking layer.

In one aspect, the first blocking layer, the core layer, and the second blocking layer are extruded during a common time period.

In another embodiment, another method (e.g., for manufacturing a card assembly) includes forming a sheet of a core layer for a card assembly, co-extruding a sheet of a blocking layer for the card assembly, and bonding the sheet of the core layer and the sheet of the blocking layer. The card assembly can be separated from the sheet of the core layer and the sheet of the blocking layer that are bonded together.

In one aspect, the sheet of the blocking layer has a thickness of no more than two mils.

In one aspect, the sheet of the blocking layer is formed from a color that prevents the sheet of the core layer from being visible through the blocking layer in the card assembly.

In one aspect, bonding the sheet of the core layer and the sheet of the blocking layer includes fusing the sheet of the blocking layer to the sheet of the core layer.

In one aspect, bonding the sheet of the core layer and the sheet of the blocking layer includes coupling the sheet of the blocking layer to the sheet of the core layer without use of an adhesive material between the sheet of the core layer and the sheet of the blocking layer.

In one aspect, the overlayer layer is a first blocking layer, and the method also can include extruding a sheet of a second blocking layer onto an opposite side of the core layer than the first blocking layer.

In one aspect, the first blocking layer, the core layer, and the second blocking layer are extruded during a common time period.

In another embodiment, a card assembly includes a core layer having opposite first and second sides, and a blocking layer having opposite first and second surfaces. The second surface of the blocking layer can be bonded to the first side of the core layer such the first surface of the blocking layer is visible. The blocking layer can have a thickness of no more than two mils while preventing color of the core layer from being visible through the first surface of the blocking layer.

In one aspect, the blocking layer is formed from a color that prevents the core layer from being visible through the first surface of the blocking layer.

In one aspect, the blocking layer is bonded to the core layer without use of an adhesive material between the blocking layer and the core layer.

In one aspect, the overlayer layer is a first blocking layer, and also including a second blocking layer on an opposite side of the core layer than the first blocking layer.

### BRIEF DESCRIPTION OF THE DRAWINGS

The present inventive subject matter will be better understood from reading the following description of non-limiting embodiments, with reference to the attached drawings (which are not necessarily drawn to scale), wherein below:

FIG. 1 is a side view of an extruded card assembly formed in accordance with one embodiment;

FIG. 2 schematically illustrates a co-extrusion system used to form a sheet of material that can be cut into one or more of the card assemblies shown in FIG. 1 according to one embodiment;

FIG. 3 schematically illustrates an extrusion system used to form a sheet of material that can be cut into one or more of the card assemblies shown in FIG. 1 according to another embodiment;

FIG. 4 is a flowchart of a method for manufacturing an extruded card assembly according to one embodiment; and

FIG. 5 is a perspective view of the card assembly shown in FIG. 1.

### DETAILED DESCRIPTION

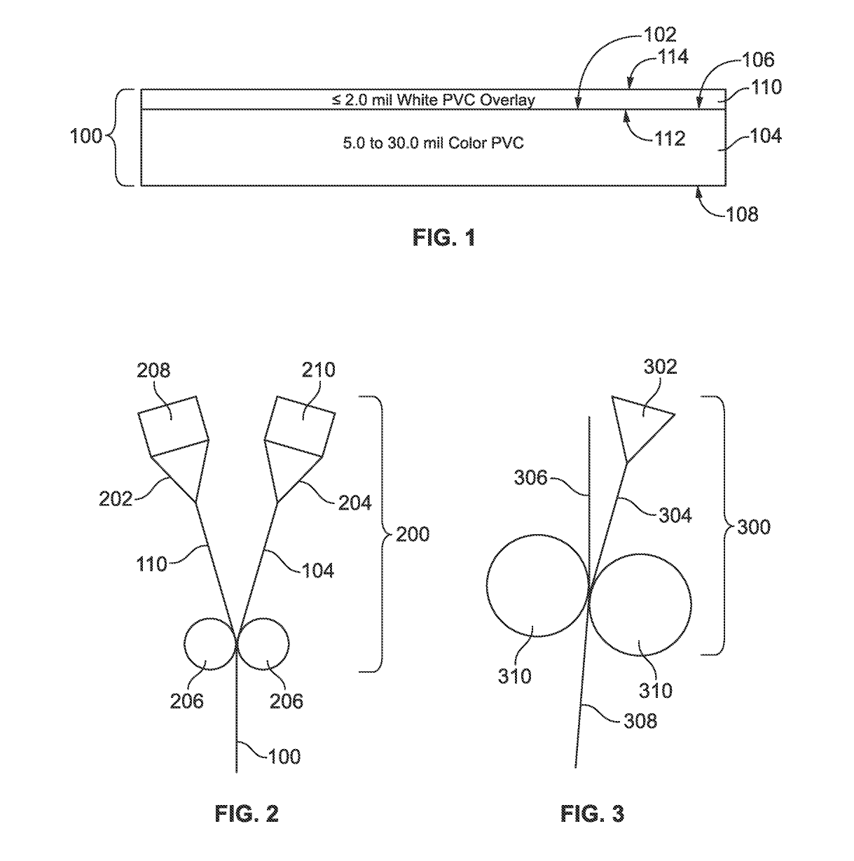

FIG. 1 is a side view of an extruded card assembly 100 formed in accordance with one embodiment. FIG. 5 is a perspective view of the card assembly 100 shown in FIG. 1. The card assembly 100 may be used in a variety of applications, such as a financial transaction card (e.g., credit or debit card, phone card, gift card, loyalty card, etc.), a security card (e.g., identification card), and the like. The card assembly 100 includes an exterior surface or side 114 and a visible surface or side 102 on which information may be printed or otherwise shown. For example, the surface or side 102 may include alphanumeric and/or other symbols 500 (shown in FIG. 5, such as text, numbers, symbols, and the like), images 502, or other indicia that indicate a use of the card assembly 100, an owner of the card assembly 100, an institution that issued and/or accepts the card assembly 100, etc. The card assembly 100 is formed from several planar sections of sheets that are coupled together. In the illustrated embodiment, the planar sheet sections include a core layer or core assembly 104 having opposite sides 106, 108 and a blocking layer 110 having the side 114 and an opposite side 112. The surface 102 on which information is printed may be the same as the side 112 or may be another surface. In one embodiment, the card assembly 100 may be formed from another core layer coupled to the side 108 of the core layer 104 shown in FIG. 1, another blocking layer coupled to the additional core layer, and the like.

The core layer 104 and/or blocking layer 110 may be formed from one or more extruded or extrudable materials (e.g., materials that are able to be extruded into one or more shapes), such as one or more polymers. Non-limiting examples of materials from which the layers 104 and/or 110 may be formed include polyvinyl chloride (PVC), polyethylene terephthalate (PET), polycarbonate (PC), copolymerized PET (PETG), or the like. In the illustrated embodiment, the core layer 104 and the blocking layer 110 are both formed from PVC that is extruded into the illustrated shapes.

The layers 104, 110 may vary in thickness. In the illustrated embodiment, the core layer 104 may be at least five mils and no greater than thirty mils thick (e.g., at least 0.1 millimeters thick and no more than 0.76 millimeters thick). Alternatively, the core layer 104 may be another thickness. Additionally, the blocking layer 110 is no thicker than two mils (e.g., no thicker than 0.05 millimeters) in the illustrated embodiment. Alternatively, the blocking layer 110 may be a thicker dimension.

100321 The core layer 104 may be formed from a material that has a visible color other than the color white. For example, the core layer 104 may be blue, red, black, orange, green, or the like. The blocking layer 110 may be formed from a material that is white. Alternatively, the blocking layer 110 may be formed from a material that is another color. Various images, text, numbers, symbols, or the like, can be printed onto the blocking layer 110.

The blocking layer 110 can provide a surface for printing customizable images, text, numbers, symbols, or the like, onto the card assembly 100. Keeping the blocking layer 110 relatively thin (e.g., no greater than two mils) can assist in preventing the color (e.g., white) of the blocking layer 110 visible from the side of the card assembly 100. As the thickness of the blocking layer 110 increases above two mils, the color of the blocking layer 110 may become more visible along the edge of the card assembly 100 to a human with normal eyesight unaided by magnification. This visibility of the blocking layer 110 may be undesirable, such as in situations where the color of the blocking layer 110 is not desired in the card assembly 100.

In one embodiment, the card assembly 100 is formed by extruding at least one of the blocking layer 110 and/or the core layer 104. Extruding the blocking layer 110 can permit the blocking layer 110 to be made relatively thin (e.g., no thicker than two mils), while also allowing the blocking layer 110 to prevent the color of the core layer 104 from being visible at the surface 102. Using other techniques to create the blocking layer 110 can result in undesirable consequences. For example, it can be difficult to laminate a blocking layer formed from PET that is no thicker than two mils to a core layer (e.g., by joining the layers using an adhesive disposed between the layers), because it can be difficult and/or expensive to form such a thin layer. Additionally, such a thin blocking layer may be formed from two dissimilar materials (e.g., colored pigments and a binder agent) and, when such materials are included in a thin layer, the layer may shrink more than the core layer and thereby cause bending of a card assembly. Such a thin blocking layer also may suffer from undesirable visual consequences, such as the pigments in the layer forming large, visible gobules.

FIG. 2 schematically illustrates a co-extrusion system 200 used to form a sheet of material that can be cut into one or more of the card assemblies 100 according to one embodiment. The co-extrusion system 200 extrudes both the blocking layer 110 and the core layer 104 at the same time (e.g., concurrently) such that the layers 104, 110 are physically bonded together. For example, the co-extrusion system 200 includes a container body 208 holding a supply of material used to form the blocking layer 110 and a container body 210 holding a supply of material used to form the core layer 104. These materials may be in a fluid state in the respective container bodies 208, 210. For example, the materials may be heated in a fluid state in the container bodies 208, 210. The materials can flow, responsive to a pushing force generated by one or more actuators (e.g., rotating screws), out of the container bodies 208, 210 and into corresponding dies 202, 204. The dies 202, 204 have openings shaped to cause the materials flowing out of the container bodies 208, 210 to be formed into the planar bodies or sheets shown in FIG. 1.

As shown in FIG. 2, the material forced out of the die 202 forms a planar sheet of the blocking layer 110 and the material forced out of the die 204 forms a planar sheet of the core layer 104. The sheets of the layers 104, 110 may begin to at least partially cool, but also may remain at least partially heated in a fluid or quasi-fluid state. The sheets of the layers 104, 110 can be physically bonded together by pushing the layers 104, 110 together between mechanical rollers 206. For example, the sheets of the layers 104, 110 can be fused together to form a single body (e.g., a sheet of the card assembly 100). The sheets of the layers 104, 110 can be fused or welded together without an adhesive being present between the layers 104, 110. The sheet of the layer 110 can be extruded at a relatively thin size, as described above.

100371 The sheet formed from the co-extrusion of the sheets of the layers 104, 110 may then be cut into one or more card assemblies 100 described above. The resultant sheet formed by the fusion of the layers 104, 110 can have a printable surface 102 (shown in FIG. 1) on the layer 110 and a colored core layer 104. Because the layers 104, 110 are physically bonded, fused, or welded together, there may not be a need to laminate the layers 104, 110 together with an adhesive. This can avoid the bending of the card assembly 100, and can reduce the cost and/or complexity of forming the card assembly 100.

In another embodiment, one or more additional sheets of the layer 110 may be co-extruded with the layers 104, 110 described above. For example, an additional container body and die may be positioned to extrude another layer 110 on the opposite side of the layer 104 so that the layer 104 has two layers 110 extruded on opposite sides of the layer 104. Optionally, two or more layers 110 may be extruded onto the same side of the layer 104 at the same time that the layer 104 is extruded.

FIG. 3 schematically illustrates an extrusion system 300 used to form a sheet of material that can be cut into one or more of the card assemblies 100 according to another embodiment. In contrast to the co-extrusion system 200 shown in FIG. 2, the extrusion system 300 extrudes only one film of the blocking layer 110 or the core layer 104 for bonding with a previously formed film of the other of the core layer 104 or the blocking layer 110. For example, the extrusion system 300 includes a container body 302 holding a supply of material used to form an extruded layer 304 by extruding the material through a die 302, similar to as described above in connection with the co-extrusion system 200. The extruded layer 304 can represent a film of the blocking layer 110 or a film of the core layer 104. A previously formed film 306 may have been created and/or solidified at an earlier time, and may represent the other film of the blocking layer 110 or the core layer 104.

As shown in FIG. 3, the material forced out of the die 302 forms the planar extruded film 304 of the blocking layer 110 or the core layer 104. The extruded film 304 is physically bonded with the pre-formed film 306 by pushing the films 304, 306 together between mechanical rollers 310. For example, the films 304, 306 can be fused together to form a single body (e.g., a film of the card assembly 100). The films 304, 306 of the layers 104, 110 can be fused or welded together without an adhesive being present between the layers 104, 110. The film of the layer 110 can be extruded at a relatively thin size, as described above, regardless of whether the film 304 or the film 306 represents the layer 110.

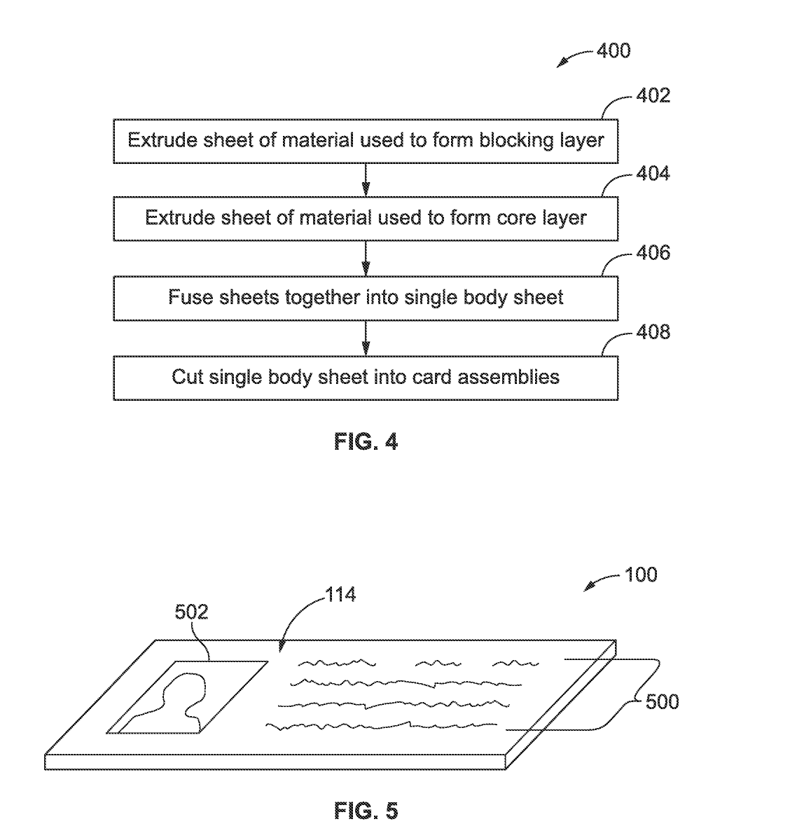

FIG. 4 is a flowchart of a method 400 for manufacturing an extruded card assembly according to one embodiment. The method 400 may be performed by one or more embodiments of the systems 200, 300 shown in FIGS. 2 and 3 to form the card assembly 100 shown in FIG. 1. At 402, material used to form the blocking layer 110 (shown in FIG. 1) is extruded into a planar film. The material may be extruded in a relatively thin dimension, such as no more than two mils thick or another dimension. At 404, material used to form the core layer 104 (shown in FIG. 1) is extruded into a planar film. The films used to form the blocking layer 110 and the core layer 104 may be co-extruded, such that the films are extruded at the same time or during the same time periods. Alternatively, one or more of the films of the layers 104, 110 may be formed at a different time and/or using a technique other than extrusion.

At 406, the films of the layers 104, 110 are fused together. In one embodiment, the films are extruded and bonded together while the materials of the films are still in a state that is heated and/or at least partially fluid. The films can then bond together and cool to form a single body sheet. The films can be bonded together without the use of an adhesive or other material between the films. The fusing of the layers 104, 110 may occur at the same time as the layers 104, 110 are co-extruded. For example, the extrusion of the layers 104, 110 may occur at elevated temperatures such that the layers 104, 110 fuse together.

At 408, the single body sheet can be cut or otherwise separated into one or more of the card assemblies 100. Alternatively, the single body sheet can be laminated to another single body sheet and then cut or otherwise separated into one or more of the card assemblies 100. For example, the core layer 104 of one sheet or card assembly 100 can be adhered to the core layer of another sheet or card assembly 100.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the inventive subject matter without departing from its scope. While the dimensions and types of materials described herein are intended to define the parameters of the inventive subject matter, they are by no means limiting and are exemplary embodiments. Many other embodiments will be apparent to one of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112(f), unless and until such claim limitations expressly use the phrase “means for” followed by a statement of function void of further structure. For example, the recitation of a “mechanism for,” “module for,” “device for,” “unit for,” “component for,” “element for,” “member for,” “apparatus for,” “machine for,” or “system for” is not to be interpreted as invoking 35 U.S.C. §112(f), and any claim that recites one or more of these terms is not to be interpreted as a means-plus-function claim.

This written description uses examples to disclose several embodiments of the inventive subject matter, and also to enable one of ordinary skill in the art to practice the embodiments of inventive subject matter, including making and using any devices or systems and performing any incorporated methods. The patentable scope of the inventive subject matter is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

The foregoing description of certain embodiments of the present inventive subject matter will be better understood when read in conjunction with the appended drawings. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” or “an embodiment” of the presently described inventive subject matter are not intended to be interpreted as excluding the existence of additional embodiments that also incorporate the recited features. Moreover, unless explicitly stated to the contrary, embodiments “comprising,” “comprises,” “including,” “includes,” “having,” or “has” an element or a plurality of elements having a particular property may include additional such elements not having that property.

1. A method comprising:
extruding a film of a core layer for a card assembly;
co-extruding a film of a blocking layer for the card assembly; and
bonding the film of the core layer and the film of the blocking layer, wherein the card assembly can be separated from the film of the core layer and the film of the blocking layer that are bonded together.

2. The method of claim 1, wherein extruding the film of the core layer and co-extruding the film of the blocking layer occurs during a common time period.

3. The method of claim 1, wherein the film of the blocking layer has a thickness of no more than two mils.

4. The method of claim 1, wherein the film of the blocking layer is formed from a color that prevents the film of the core layer from being visible through the blocking layer in the card assembly.

5. The method of claim 1, wherein bonding the film of the core layer and the film of the blocking layer includes fusing the film of the blocking layer to the film of the core layer.

6. The method of claim 1, wherein bonding the film of the core layer and the film of the blocking layer includes coupling the film of the blocking layer to the film of the core layer without use of an adhesive material between the film of the core layer and the film of the blocking layer.

7. The method of claim 1, wherein the overlayer layer is a first blocking layer, and further comprising extruding a film of a second blocking layer onto an opposite side of the core layer than the first blocking layer.

8. The method of claim 7, wherein the first blocking layer, the core layer, and the second blocking layer are extruded during a common time period.

9. A method comprising:
forming a film of a core layer for a card assembly;
extruding a film of a blocking layer for the card assembly; and
bonding the film of the core layer and the film of the blocking layer, wherein the card assembly can be separated from the film of the core layer and the film of the blocking layer that are bonded together.

9. The method of claim 8, wherein the film of the blocking layer has a thickness of no more than two mils.

10. The method of claim 8, wherein the film of the blocking layer is formed from a color that prevents the film of the core layer from being visible through the blocking layer in the card assembly.

11. The method of claim 8, wherein bonding the film of the core layer and the film of the blocking layer includes fusing the film of the blocking layer to the film of the core layer.

12. The method of claim 8, wherein bonding the film of the core layer and the film of the blocking layer includes coupling the film of the blocking layer to the film of the core layer without use of an adhesive material between the film of the core layer and the film of the blocking layer.

13. The method of claim 8, wherein the overlayer layer is a first blocking layer, and further comprising extruding a film of a second blocking layer onto an opposite side of the core layer than the first blocking layer.

14. The method of claim 13, wherein the first blocking layer, the core layer, and the second blocking layer are extruded during a common time period.

15. A card assembly comprising:
a core layer having opposite first and second sides; and
a blocking layer having opposite first and second surfaces, the second surface of the blocking layer bonded to the first side of the core layer such the first surface of the blocking layer is visible, the blocking layer having a thickness of no more than two mils and preventing color of the core layer from being visible through the first surface of the blocking layer.

16. The card assembly of claim 15, wherein the blocking layer is formed from a color that prevents the core layer from being visible through the first surface of the blocking layer.

17. The card assembly of claim 15, wherein the blocking layer is bonded to the core layer without use of an adhesive material between the blocking layer and the core layer.

18. The card assembly of claim 15, wherein the overlayer layer is a first blocking layer, and also including a second blocking layer on an opposite side of the core layer than the first blocking layer.
